(19) United States
(12) Patent Application Publication
(10) Pub. No.: US 2026/0267432 A1
(43) Pub. Date: Sep. 10, 2026

(54) INPUT DEVICE AND CONTROL METHOD FOR CONTROLLING INPUT DEVICE

(71) Applicant: Panasonic Automotive Systems Co., Ltd., Kanagawa (JP)

(72) Inventor: Shigeru YAMANE, Osaka (JP)

(73) Assignee: Panasonic Automotive Systems Co., Ltd., Kanagawa (JP)

(21) Appl. No.: 19/444,716

(22) Filed: Jan. 9, 2026

(30) Foreign Application Priority Data
Mar. 5, 2025 (JP) 2025-034687

(51) Int. Cl. G06F 3/041; G06F 3/01

(52) U.S. Cl. CPC G06F 3/0416; G06F 3/016

(57) ABSTRACT

An input device includes: an operation panel that includes an input area for receiving touch input from an operating body and a non-input area not for receiving the touch input; a touch sensor that detects a position touched by the operating body, the position being located in the input area on the operation panel; a vibrator; and a control circuit that causes the vibrator to vibrate at least the non-input area on the operation panel by controlling the vibrator when the position touched by the operating body has moved from the input area to the non-input area with the operating body touching the operation panel.

### CROSS REFERENCE TO RELATED APPLICATION

The present application is based on and claims priority of Japanese Patent Application No. 2025-034687 filed on Mar. 5, 2025.

### FIELD

The present disclosure relates to an input device and a control method for controlling the input device.

### BACKGROUND

Conventionally, there have been devices capable of receiving touch input. Patent Literature (PTL) 1 discloses a protective panel with a touch input function, including: a window capable of receiving touch input; and a fine concave/convex portion. PTL 2 discloses a touch panel including a touch-invalid area whose edge portion has a first texture and a touch-valid area whose edge portion has a second texture.

As disclosed in PTL 1 and PTL 2, the panel that receives touch input is surface-treated by, for example, providing a concave/convex portion. This enables a user who performs touch input to recognize, for example, where on the touch panel the user is touching, without visually checking the touch panel.

### Citation List

### Patent Literature

PTL 1: WO 2008/111505

PTL 2: Japanese Unexamined Patent Application Publication No. 2017-174027

### SUMMARY

However, the panels described in PTL 1 and PTL 2 can be improved upon.

In view of this, the present disclosure provides an input device and so forth capable of improving upon the above related art.

The input device according to an aspect of the present disclosure is an input device including: an operation panel that includes an input area for receiving touch input from an operating body and a non-input area not for receiving the touch input; a touch sensor that detects a position touched by the operating body, the position being located in the input area on the operation panel; a vibrator; and a control circuit that causes the vibrator to vibrate at least the non-input area on the operation panel by controlling the vibrator when the position touched by the operating body has moved from the input area to the non-input area with the operating body touching the operation panel.

The input device according to another aspect of the present disclosure is an input device including: an operation panel that includes an input area for receiving touch input from an operating body and a non-input area not for receiving the touch input; a touch sensor that detects a position touched by the operating body, the position being located in the input area on the operation panel; a vibrator; and a control circuit that controls the vibrator. Here, the input area includes a first input area and a second input area that is located closer to the non-input area than the first input area is, and the control circuit causes the vibrator to vibrate the second input area by controlling the vibrator when the position touched by the operating body has moved from the first input area to the second input area with the operating body touching the operation panel.

The control method for controlling an input device according to an aspect of the present disclosure is a control method for controlling an input device including: an operation panel that includes an input area for receiving touch input from an operating body and a non-input area not for receiving the touch input; a touch sensor that detects a position touched by the operating body, the position being located in the input area on the operation panel; and a vibrator. The foregoing control method includes: causing the vibrator to vibrate at least the non-input area on the operation panel by controlling the vibrator when the position touched by the operating body has moved from the input area to the non-input area with the operating body touching the operation panel.

With the input device and so forth according to the present disclosure, it is possible to further improve upon the above related art.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a diagram showing the interior of a vehicle in which an input device according to an embodiment is located.

FIG. 2 is a block diagram showing an input system that includes the input device according to the embodiment.

FIG. 3 is a diagram showing the configuration of the input device according to the embodiment.

FIG. 4 is a diagram for describing a first input area and a second input area according to the embodiment.

FIG. 5 is a flowchart showing Example 1 of the procedure of processing performed by the input device according to the embodiment.

FIG. 6 is a flowchart showing Example 2 of the procedure of processing performed by the input device according to the embodiment.

FIG. 7 is a diagram showing the configuration of an input device according to Variation 1.

FIG. 8 is a diagram showing the configuration of an input device according to Variation 2.

### DESCRIPTION OF EMBODIMENT

### Overview of the Present Disclosure

Conventionally, there have been known touch input-enabled input devices for remotely operating, for example, display devices. The user of such an input device usually performs touch input without looking at his/her hands. As in this case, when the user operates the input device without looking at his/her hands, a user’s finger that has traced the top surface of the operation panel included in the input device to receive touch input is likely to move to outside the area for receiving touch input (such area is also referred to as the “input area”). In particular, when the input area and an area not for receiving touch input (non-input area) are contiguously present on the same surface of the operation panel, it is difficult for the user to recognize whether the finger has moved to outside the input area. When the user’s finger has moved to outside the input area while the user is performing touch input, the input device determines that no touch input is currently received. As a result, the operation performed by the user will be interrupted.

To warn the user of that his/her finger has moved to outside the input area, conventional panels include, for example, a concave/convex portion formed in the non-input area and a raised portion formed at the boundary between the input area and the non-input area.

However, the concave/convex portion and raised portion as described above impair the visual quality, posing a problem that the design quality from the appearance point of view is decreased. For example, input devices such as the protective panel in PTL 1 and the touch panel in PTL 2 are also required to be well designed. However, in the protective panel in PTL 1, a noticeable difference is present in appearance between the areas where the fine concave/convex portion is formed and not formed. In the touch panel in PTL 2, the touch-valid area and the touch-invalid area have different textures, making the boundary between the touch-valid area and the touch-invalid area conspicuous.

In view of the above, the inventors of the present application have arrived at the creation of the present disclosure. Specifically, the present disclosure provides an input device and so forth capable of preventing a decrease in the design quality and facilitating the recognition of a position touched by an operating body. More specifically, when a finger reaches the boundary between the input area on the top surface of the operation panel that receives touch input from the user and the non-input area located on the outer side of the input area in a plan view of the operation panel, the input device according to an aspect of the present disclosure vibrates the top surface of the operation panel to warn that the finger has moved (or is about to move) to outside the input area. This enables the operation performed by the user less likely to be interrupted and enables the operation panel to have a design with a seamless top surface.

The following shows example techniques achieved from the descriptions disclosed by this DESCRIPTION, and describes effects, etc. achieved from such example techniques.

Technique 1 is an input device including: an operation panel that includes an input area for receiving touch input from an operating body and a non-input area not for receiving the touch input; a touch sensor that detects a position touched by the operating body, the position being located in the input area on the operation panel; a vibrator; and a controller that causes the vibrator to vibrate at least the non-input area on the operation panel by controlling the vibrator when the position touched by the operating body has moved from the input area to the non-input area with the operating body touching the operation panel.

The operating body is, for example, the user or an instrument such as a stylus used by the user. With the input device, it is possible to enable the user to recognize, through vibration, that the position touched by the operating body has moved to outside the input area, for example, without the need for the operation panel having different surface shapes for the input area and for the non-input area. With the foregoing input device, it is thus possible to prevent a decrease in the design quality and facilitate the recognition of the position touched by the operating body.

Technique 2 is the input device according to Technique 1. In this input device, the controller causes the vibrator to: vibrate at least the non-input area on the operation panel when the position touched by the operating body has moved from the input area to the non-input area with the operating body touching the operation panel; and stop vibrating when the touch sensor detects a touch by the operating body in the input area before a first predetermined period elapses after the position touched by the operating body has moved from the input area to the non-input area, or when the first predetermined period has elapsed.

With this, it is possible to prevent a vibration from unnecessarily generated, when the position touched by the operating body has returned to the input area or remains located in the non-input area.

Technique 3 is the input device according to Technique 1. In this input device, the controller causes the vibrator to vibrate the non-input area at a vibration intensity that is based on a movement speed when the position touched by the operating body has moved from the input area to the non-input area with the operating body touching the operation panel. Here, the movement speed is a speed at which the position touched by the operating body moves.

When the user performs touch input with a finger, for example, the touch pressure of the finger and the touch area between the finger and the operation panel are considered to become smaller as the movement speed of the finger is higher. Stated differently, there is a concern that the user may be less sensitive to the vibration as the movement speed of the finger is higher. In view of this, by increasing the vibration intensity with an increasing speed of the movement speed, for example, it is possible to prevent the user from becoming less sensitive to the vibration depending on the movement speed of the position touched by the operating body.

Technique 4 is the input device according to Technique 2. In this input device, the input area includes a first input area and a second input area that is located closer to the non-input area than the first input area is, and the controller causes the vibrator to vibrate the second input area when the position touched by the operating body has moved from the first input area to the second input area with the operating body touching the operation panel.

With this, it is possible to enable the user to recognize that the operating body is highly likely to move to the non-input area, before the operating body actually moves to the non-input area.

Technique 5 is the input device according to Technique 4. In this input device, the controller causes the vibrator to vibrate the second input area with a vibration of the second input area intensified as the position touched by the operating body approaches the non-input area when the position touched by the operating body has moved from the first input area to the second input area with the operating body touching the operation panel.

With this, it is possible to notify the user of that the operating body is highly likely to move to the non-input area, before the operating body actually moves to the non-input area. This enables the user to easily recognize that the operating body is highly likely to move to the non-input area, even when the movement speed of the operating body is low.

Technique 6 is the input device according to Technique 4 or 5. In this input device, the controller causes the vibrator to vibrate the second input area for a second predetermined period that is shorter than the first predetermined period when the position touched by the operating body has moved from the first input area to the second input area with the operating body touching the operation panel.

With this, it is possible to notify the user of that the operating body is highly likely to move to the non-input area, before the operating body actually moves to the non-input area. With this, it is possible to generate a vibration for the user once and further stop the vibration before the position touched by the operating body actually moves from the input area to the non-input area. This thus enables the user to easily recognize that the operating body is highly likely to move to the non-input area, even when the movement speed of the operating body is high.

Technique 7 is the input device according to any one of Techniques 4 to 6. In this input device, when the position touched by the operating body has moved from the first input area to the second input area with the operating body touching the operation panel, the controller causes the vibrator to vibrate the second input area based on a movement speed (i) with a vibration of the second input area intensified as the position touched by the operating body approaches the non-input area or (ii) for a second predetermined period that is shorter than the first predetermined period. Here, the movement speed is a speed at which the position touched by the operating body moves.

The ease with which the user recognizes a vibration can vary depending on the movement speed of the operating body. In view of this, by determining the manner in which the vibration is generated on the basis of the movement speed of the operating body, it becomes easier for the user to recognize the vibration.

Technique 8 is the input device according to any one of Techniques 4 to 7. In this input device, the controller determines, based on a movement speed, a timing at which the vibrator starts vibrating when the position touched by the operating body has moved from the input area to the non-input area. Here, the movement speed is a speed at which the position touched by the operating body moves.

Due to the time taken to transmit a control signal for causing the vibrator to vibrate and the time lag until a vibration is generated, it is more likely that the position touched by the operating body will move to outside the input area before the vibration is generated as the movement speed of the operating body is higher. In view of this, with the input device according to Technique 8, it is possible to cause the vibrator to vibrate at the timing that takes into account the time taken to transmit the control signal for causing the vibrator to vibrate and the time lag until the vibration is generated. This thus makes it easier for the user to recognize the vibration.

Technique 9 is the input device according to any one of Techniques 4 to 8. In this input device, the controller determines, based on a movement speed, a timing at which the vibrator starts vibrating when the position touched by the operating body has moved from the first input area to the second input area. The movement speed is a speed at which the position touched by the operating body moves.

With this, it is possible to cause the vibrator to vibrate the second input area at the timing that takes into account the time taken to transmit the control signal for causing the vibrator to vibrate and the time lag until the vibration is generated. This thus makes it easier for the user to recognize the vibration.

Technique 10 is the input device according to any one of Techniques 4 to 9. In this input device, the controller causes the vibrator to vibrate the second input area at a vibration intensity that is based on a movement speed when the position touched by the operating body has moved from the first input area to the second input area with the operating body touching the operation panel. Here, the movement speed is a speed at which the position touched by the operating body moves.

With this, it is possible to prevent the user from becoming less sensitive to the vibration depending on the movement speed of the position touched by the operating body.

Technique 11 is the input device according to any one of Techniques 4 to 10. In this input device, the controller causes the vibrator to vibrate the input area at a second vibration intensity that is weaker than a first vibration intensity when the touch sensor detects a touch by the operating body in the input area. Here, the first vibration intensity is a vibration intensity used for a case where the position touched by the operating body has moved from the input area to the non-input area with the operating body touching the operation panel.

With this, it is possible to enable the user to recognize that the position touched by the operating body is present in the input area separately from that the position touched by the operating body is present in the non-input area.

Technique 12 is the input device according to Technique 11. In this input device, the controller causes the vibrator to vibrate the first input area at the second vibration intensity when the touch sensor detects a touch by the operating body in the first input area out of the first input area and the second input area.

When touch input is performed in the vicinity of the boundary between the input area and the non-input area, it is highly likely that the position touched by the operating body will immediately move to outside the input area due to a subsequent movement of the operating body, compared to when touch input is performed at a position distant from the vicinity of the boundary within the input area. In view of this, with the input device according to Technique 12, by causing the vibrator to vibrate when touch input is performed at a position that is distant from the vicinity of the boundary within the input area, rather than in the vicinity of the boundary between the input area and the non-input area, it is possible to enable the user to recognize that the position touched by the operating body is present in the input area and not in the vicinity of the boundary. Furthermore, with the input device according to Technology 12, for example, it is possible to cause the vibrator not to vibrate when touch input is performed in the vicinity of the boundary between the input area and the non-input area. In this case, since it becomes easier for the user to recognize whether the user has performed the touch input in the vicinity of the boundary, it is possible to prevent the position touched by the operating body from immediately moving to outside the input area due to a subsequent movement of the operating body, even when the user performs touch input in the vicinity of the boundary.

Technique 13 is the input device according to Technique 11 or 12. In this input device, the controller causes the vibrator to stop vibrating when the touch sensor detects a movement of the position touched by the operating body after detecting a touch by the operating body in the first input area.

Depending on the details of the control performed in response to touch input to the input device, control can be performed in some cases to provide, for example, feedback to the user by vibrating the operation panel. In view of this, by causing the vibrator to stop the vibration for notifying that the operating body has touched the first input area, when a movement of the position touched by the operating body has been detected, it is possible not to interference with such control for feedback. It is also possible not to interference with the vibration that is generated when the position touched by the operating body has moved from the input area to the non-input area.

Technique 14 is the input device according to any one of Techniques 1 to 13. In this input device, the non-input area includes a first non-input area and a second non-input area that is farther from the input area than the first non-input area is, and the input area and the first non-input area are thinner than the second non-input area.

With this, a thinned portion is provided in the operation panel, thereby making it easier for the vibrator to vibrate the operation panel. In particular, when the overall thickness of the operation panel is large, a thinned portion provided in the operation panel, even partially, enables the vibrator to easily vibrate the operation panel.

Technique 15 is the input device according to any one of Techniques 1 to 14. In this input device, the operation panel includes a groove portion in the non-input area, which is a portion provided in the operation panel on an outer side relative to a connection point in a plan view. Here, the connection point is located between the operation panel and a vibration device fixing component to which the vibrator is connected.

With this, since the groove portion is thinner than the other portions in the operation panel, it becomes easier for the vibrator to vibrate the operation panel.

Technique 16 is an input device including: an operation panel that includes an input area for receiving touch input from an operating body and a non-input area not for receiving the touch input; a touch sensor that detects a position touched by the operating body, the position being located in the input area on the operation panel; a vibrator; and a controller that controls the vibrator. Here, the input area includes a first input area and a second input area that is located closer to the non-input area than the first input area is, and the controller causes the vibrator to vibrate the second input area by controlling the vibrator when the position touched by the operating body has moved from the first input area to the second input area with the operating body touching the operation panel.

With this, it is possible to enable the user to recognize, through vibration, that the position touched by the operating body is about to move to outside the input area, for example, without the need for the operation panel having different surface shapes for the input area and for the non-input area. With the input device, it is thus possible to prevent a decrease in the design quality and facilitate the recognition of the position touched by the operating body.

Technique 17 is the input device according to Technique 16. In this input device, the controller causes the vibrator to vibrate the second input area at a vibration intensity that is based on a movement speed when the position touched by the operating body has moved from the first input area to the second input area with the operating body touching the operation panel. Here, the movement speed is a speed at which the position touched by the operating body moves.

With this, it is possible to prevent the user from becoming less sensitive to the vibration depending on the movement speed of the position touched by the operating body.

Technique 18 is the input device according to Technique 16 or 17. In this input device, the controller causes the vibrator to vibrate the second input area with a vibration of the second input area intensified as the position touched by the operating body approaches the non-input area when the position touched by the operating body has moved from the first input area to the second input area with the operating body touching the operation panel.

With this, it is possible to notify the user of that the operating body is highly likely to move to the non-input area, before the operating body actually moves to the non-input area. This thus enables the user to easily recognize that the operating body is highly likely to move to the non-input area, particularly when the movement speed of the operating body is low.

Technique 19 is the input device according to any one of Techniques 16 to 18. In this input device, the controller determines, based on a movement speed, a timing at which the vibrator starts vibrating when the position touched by the operating body has moved from the first input area to the second input area. Here, the movement speed is a speed at which the position touched by the operating body moves.

With this, it is possible to cause the vibrator to vibrate at the timing that takes into account the time taken to transmit the control signal for causing the vibrator to vibrate and the time lag until the vibration is generated. This thus makes it easier for the user to recognize the vibration.

Technique 20 is the input device according to any one of Techniques 16 to 19. In this input device, the non-input area includes a first non-input area and a second non-input area that is farther from the input area than the first non-input area is, and the input area and the first non-input area are thinner than the second non-input area.

With this, a thinned portion is provided in the operation panel, thereby making it easier for the vibrator to vibrate the operation panel. In particular, when the overall thickness of the operation panel is large, a thinned portion provided in the operation panel, even partially, enables the vibrator to easily vibrate the operation panel.

Technique 21 is the input device according to any one of Techniques 16 to 20. In this input device, the operation panel includes a groove portion in the non-input area, which is a portion provided in the operation panel on an outer side relative to a connection point in a plan view. Here, the connection point is located between the operation panel and a vibration device fixing component to which the vibrator is connected.

With this, since the groove portion is thinner than the other portions in the operation panel, it becomes easier for the vibrator to vibrate the operation panel.

Technique 22 is a control method for controlling an input device including: an operation panel that includes an input area for receiving touch input from an operating body and a non-input area not for receiving the touch input; a touch sensor that detects a position touched by the operating body, which is a position located in the input area on the operation panel; and a vibrator. The foregoing control method includes: causing the vibrator to vibrate at least the non-input area on the operation panel by controlling the vibrator when the position touched by the operating body has moved from the input area to the non-input area with the operating body touching the operation panel.

With this, it is possible to achieve the same effects as those achieved by the input device.

Technique 23 is a control method for controlling an input device including: an operation panel that includes an input area for receiving touch input from an operating body and a non-input area not for receiving the touch input; a touch sensor that detects a position touched by the operating body, which is a position located in the input area on the operation panel; and a vibrator. Here, the input area includes a first input area and a second input area that is located closer to the non-input area than the first input area is. The foregoing control method includes: causing the vibrator to vibrate the second input area by controlling the vibrator when the position touched by the operating body has moved from the first input area to the second input area with the operating body touching the operation panel.

With this, it is possible to achieve the same effects as those achieved by the input device.

These general or specific aspects may be implemented using a system, a method, an integrated circuit, a computer program, or a non-transitory recording medium such as a computer-readable CD-ROM, or may also be implemented using any combination of systems, methods, integrated circuits, computer programs, or recording media. The program may be stored in the recording medium in advance, or may be supplied to the recording medium over a wide area network such as the Internet.

Hereinafter, a certain exemplary embodiment is described in greater detail with reference to the accompanying Drawings.

The exemplary embodiment described below shows a general or specific example. The numerical values, shapes, elements, the arrangement and connection of the elements, steps, the processing order of the steps etc. shown in the following exemplary embodiment are mere examples, and thus do not limit the scope of the present disclosure. Therefore, among the elements in the following exemplary embodiment, those not recited in any one of the independent claims are described as optional elements.

Also, the drawings are not always strictly drawn. Thus, the drawings are not always drawn to scale, for example. In the drawings, the same reference signs are given to substantially the same elements, and duplication of descriptions of the substantially the same elements will be omitted or simplified in some cases.

In this DESCRIPTION, the numerical values and the ranges of numerical values express not only their strict meanings but also mean substantially the same range such as that an error on the order of a few percent (or on the order of 10%) is included.

Also, in this DESCRIPTION, the ordinal numbers such as “first” and “second” do not mean the number of the elements or the order of the elements unless otherwise specified. The ordinal numbers are used for the purpose of distinguishing between the same type of elements to avoid confusion.

Also, in this DESCRIPTION and the drawings, the X-axis, the Y-axis, and the Z-axis indicate the three axes of a three-dimensional Cartesian coordinate system. When the operation panel is in a rectangular shape in a plan view, the X-axis and the Y-axis are directions parallel to a first side of the rectangular shape and a second side perpendicular to the first side, respectively. The Z-axis is the thickness direction of the operation panel. In this DESCRIPTION, “thickness direction” of the operation panel refers to the direction vertical to the main surface (the surface that receives touch input) of the operation panel.

Also, “in a plan view of the operation panel” is synonymous with “in a plan view of the main surface of the operation panel”, and means to view an object that is orthographically projected onto the XY plane from the positive side of the Z-axis. In the DESCRIPTION, “plan view” means “plan view of the main surface of the operation panel” unless otherwise specified. Also, the surface of the operation panel opposing the main surface is also referred to as “the back surface”.

### Embodiment

### Configuration

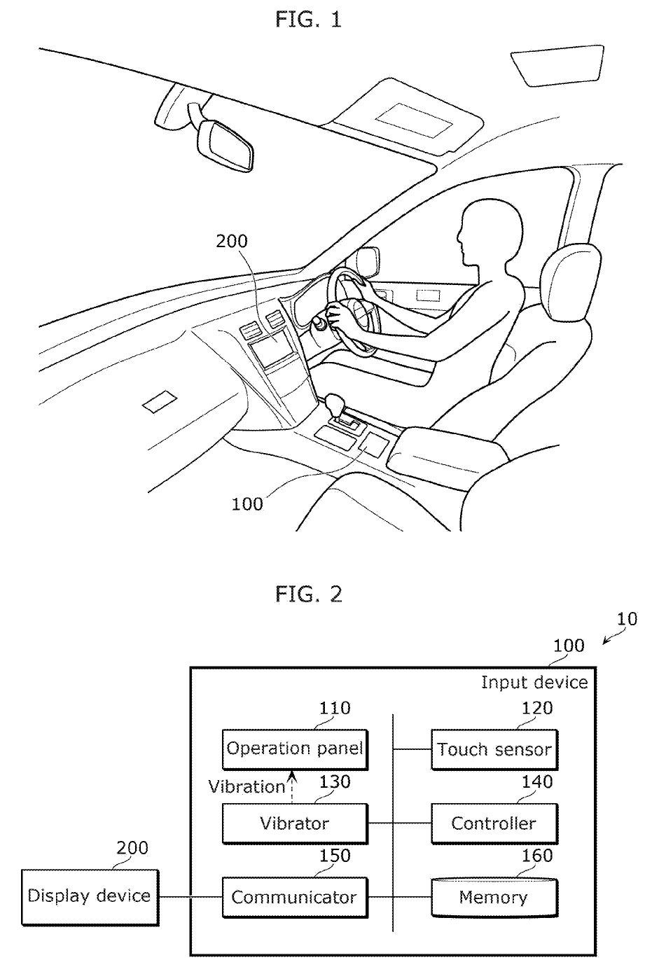

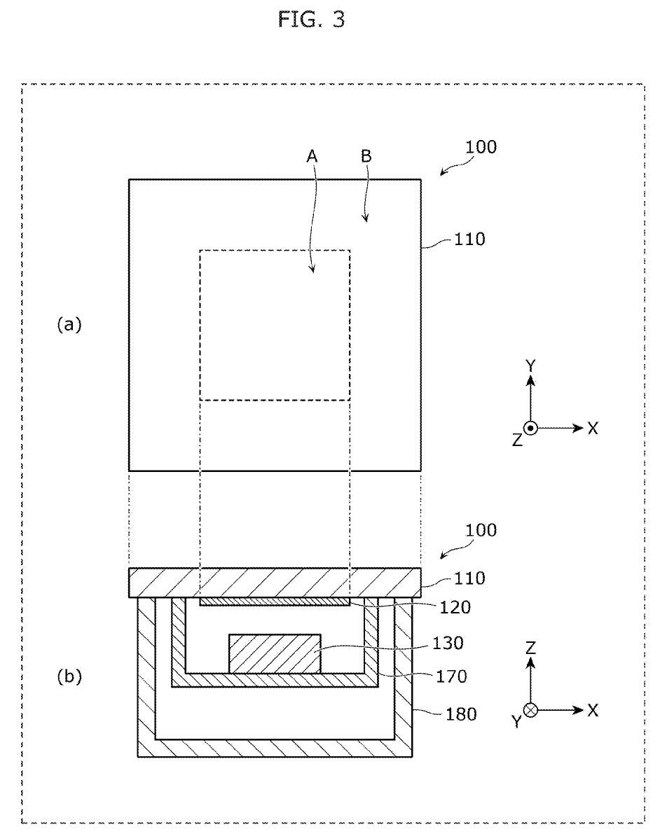

FIG. 1 is a diagram showing the interior of a vehicle in which input device 100 according to the embodiment is located. FIG. 2 is a block diagram showing input system 10 that includes input device 100 according to the embodiment. FIG. 3 is a diagram showing the configuration of input device 100 according to the embodiment. More specifically, (a) in FIG. 3 is a plan view of input device 100 when the surface of the operation panel that receives touch input from an operating body (such surface is also referred to as “the main surface”) is viewed from the top, and (b) in FIG. 3 is a cross-sectional view showing the internal configuration of input device 100.

Note that FIG. 2 omits some of the illustrations of some of the elements included in input device 100, such as vibration device fixing component 170. Similarly, FIG. 3 omits some of the illustrations of some of the elements included in input device 100, such as controller 140. Controller 140, communicator 150, and memory 160 are housed, for example, in main body cover 180, but may also be located outside main body cover 180.

Input system 10 is a system that receives, from the user, an operation performed by the user using input device 100 and controls display device 200 in response to the received operation. Using input device 100, the user operates, for example, scrolling and selecting of the menu screen, inputting of characters, moving/enlarging/minimizing of a map, etc. on video displayed on the display device.

Input system 10 includes input device 100 and display device 200.

Input device 100 is a device that receives touch input from the operating body and performs processing corresponding to the received touch input. Input device 100 is, for example, an operation input device for operating a function displayed on display device 200.

Input device 100 is used, for example, as an operation input device used for display device 200 provided in a mobile object such as a vehicle and an aircraft, or in a facility. FIG. 1 illustrates an example case where input device 100 is included in a vehicle. Input device 100 is located, for example, at a position in the vehicle such as the steering wheel, a door panel, the center console, the instrument panel, the overhead console, and/or the sun visor. To increase the design quality, operation panel 110 included in input device 100 may be incorporated as an integral part of these panels, depending on the case, to enable operation panel 110 to appear to be visually integrated and have a seamless appearance.

Input device 100 receives touch input (input operation performed by touching operation panel 110) from the operating body, thereby operating display device 200 included in the vehicle. The operating body is, for example, the user (or more specifically, a user’s finger) or a stylus. Through this, display device 200 displays video corresponding to the touch input. The following describes an example case where the operating body is the user and the user performs touch input with one or more fingers (hereinafter simply referred to as “finger”).

Display device 200 is a display that shows video. Display device 200 is communicatively connected to input device 100, for example, and performs processing on the basis of touch input received by input device 100.

Note that display device 200 is simply required to be capable of displaying video, and may be, for example, a projector that projects video onto the front windshield or a door glass included in the vehicle, or may be a head-up display.

Input device 100 includes operation panel 110, touch sensor 120, vibrator 130, controller 140, communicator 150, memory 160, vibration device fixing component 170, and main body cover 180.

Operation panel 110 is a cover member having a rectangular plate-like or sheet-like shape in a plan view. Operation panel 110 is stacked on touch sensor 120 to cover touch sensor 120. As such, the user performs touch input to touch sensor 120 by performing an operation on the top surface of operation panel 110, such as sliding, tapping, swiping, flicking, pinching-in, pinching-out, pressing, etc.

Note that operation panel 110 is in a rectangular shape in a plan view, but the shape of operation panel 110 in a plan view is not limited to a specific shape; the shape of operation panel 110 may thus be any shapes such as another polygonal shape and a circular shape.

Also, the size of operation panel 110 may be freely defined without being limited to a specific size. Operation panel 110 may be, for example, a 10 cm × 10 cm square in a plan view, or may be a 10 cm × 20 cm rectangle in a plan view. Also, the thickness (the width in the Z-axis direction) of operation panel 110 is, for example, 4 mm, but may be freely defined without being limited to a specific thickness.

Operation panel 110 is formed using a material such as polycarbonate, acrylic, and/or Acrylonitrile Butadiene Styrene (ABS) resin, glass, etc.

Operation panel 110 includes input area A and non-input area B. More specifically, operation panel 110 includes input area A for receiving touch input from the user and non-input area B not for receiving such touch input. Even more specifically, the main surface of operation panel 110 includes input area A and non-input area B.

Input area A is the area for receiving touch input. Touch sensor 120 is provided on the back surface of input area A, which is the surface opposing the main surface of operation panel 110. More specifically, input area A is an area that overlaps touch sensor 120 when operation panel 110 and touch sensor 120 are viewed in an overlaid manner (i.e., in a plan view of operation panel 110). For this reason, when the user performs touch input on the top surface (main surface) of operation panel 110 in input area A, touch sensor 120 receives such touch input. More specifically, when the user touches (performs touch input in) input area A (more specifically, input area A on the main surface of operation panel 110), touch sensor 120 detects the position touched by the user (i.e., the touch-input position where the touch input was performed by the user).

Furthermore, input area A is located in the central portion on the main surface of operation panel 110 in a plan view. This enables the user to easily perform touch input in input area A.

Non-input area B is an area other than input area A on operation panel 110, and is an area not for receiving touch input from the user. Touch sensor 120 is not provided, for example, on the back surface of non-input area B, which is the surface opposing the main surface of operation panel 110. In other words, non-input area B is the area that does not overlap touch sensor 120 when operation panel 110 and touch sensor 120 are viewed in an overlaid manner. For this reason, when the user performs touch input on the top surface of operation panel 110 in non-input area B, touch sensor 120 does not receive such touch input. More specifically, even when the user touches (performs touch input in) non-input area B (more specifically, non-input area B on the main surface of operation panel 110), touch sensor 120 does not detect the position touched by the user (i.e., the touch-input position where the touch input was performed by the user).

Non-input area B is located around input area A in a manner that non-input area B borders the outer perimeter of input area A and surrounds input area A. Stated differently, non-input area B is an area on the outer edge side of operation panel 110.

Note that the shapes of input area A and non-input area B in a plan view may be freely defined without being limited to specific shapes.

The main surface of operation panel 110 has a smooth shape, for example, having no concave/convex portion. In other words, the main surface of operation panel 110 is a seamless surface. The main surface of operation panel 110 is configured, for example, for the user not to perceive the boundary between input area A and non-input area B visually or through touching.

Note that the main surface of operation panel 110 may either be planar or curved.

Touch sensor 120 is a sensor that detects touch input from the user. More specifically, touch sensor 120 detects the position touched by the user in input area A on operation panel 110. Touch sensor 120 is, for example, a capacitive sensor film.

Note that touch sensor 120 may also be a touch sensor other than a capacitive touch sensor.

Touch sensor 120 overlaps at least input area A when touch sensor 120 and operation panel 110 are viewed in an overlaid manner. Stated differently, touch sensor 120 is located to be in correspondence with input area A such that touch sensor 120 is able to receive, from the user, touch input performed in input area A on operation panel 110. For this reason, touch sensor 120 receives touch input at least in input area A.

Touch sensor 120 outputs, to controller 140, a signal corresponding to the touch input received from the user.

Vibrator 130 is a vibration device for vibrating operation panel 110. Vibrator 130 is realized, for example, in the form of an actuator such as a motor, a solenoid, a Linear Resonant Actuator (LRA), a Voice Coil Motor (VCM), and/or a piezoelectric element.

Note that vibrator 130 may be configured to vibrate the whole of operation panel 110 or to vibrate any desired positions in operation panel 110. For example, an actuator may be provided, connected to a desired position in operation panel 110 to vibrate operation panel 110 partially at such desired position. Vibrator 130 may include a single actuator or a plurality of actuators.

Vibrator 130 vibrates, for example, at least non-input area B on operation panel 110. Vibrator 130 may also vibrate the whole of operation panel 110.

Note that the amplitude and the frequency at which vibrator 130 vibrates operation panel 110 may be freely defined without being limited to specific amplitude and frequency. The amplitude and the frequency may be freely set in accordance with the material and the configuration of input device 100. For example, vibrator 130 vibrates operation panel 110 at 50 Hz to 600 Hz.

Controller 140 is a processing unit that controls input device 100. More specifically, controller 140 controls the devices included in input device 100, such as vibrator 130 and communicator 150. Controller 140 obtains a signal outputted from touch sensor 120 and controls display device 200 on the basis of the obtained signal. Controller 140 locates the position touched by the user on operation panel 110 (the input position where the user performed the input), for example, on the basis of a change in capacitance in touch sensor 120 indicated by the signal. Controller 140 then communicates with display device 200 in accordance with the located input position.

Controller 140 is implemented, for example, using a memory and a processor such as a Central Processing Unit (CPU) that executes a control program stored in the memory. Controller 140 may also be configured using, for example, an exclusive control circuit or a general-purpose processor.

Controller 140 determines whether the position touched by the user has moved from input area A to non-input area B with the user touching operation panel 110, for example, and controls vibrator 130 on the basis of the result of such determination. When the position touched by the user has moved from input area A to non-input area B with the user touching operation panel 110, for example, controller 140 cause vibrator 130 to vibrate at least non-input area B on operation panel 110 by controlling vibrator 130. Stated differently, when controller 140 determines, on the basis of the result of the detection by touch sensor 120, that the position touched by the user has moved from input area A to non-input area B with the user touching operation panel 110, for example, controller 140 causes vibrator 130 to generate a vibration (warning vibration) in operation panel 110. Meanwhile, when controller 140 determines that the position touched by the user has not moved from input area A to non-input area B with the user touching operation panel 110, for example, controller 140 does not cause vibrator 130 to vibrate.

Controller 140 determines, for example, whether the position of the user’s finger continuously detected by touch sensor 120 has moved to the outer edge of input area A in a plan view. Stated differently, controller 140 determines, for example, whether the position of the user’s finger continuously detected by touch sensor 120 has been detected at the outer edge of input area A. When the position of the user’s finger continuously detected by touch sensor 120 has moved to the outer edge of input area A in a plan view, for example, controller 140 determines that the position touched by the user has moved from input area A to non-input area B. Meanwhile, when the position of the user’s finger continuously detected by touch sensor 120 has not moved to the outer edge of input area A, for example, controller 140 determines that the position touched by the user has not moved from input area A to non-input area B.

Alternatively, controller 140 determines, for example, whether the position of the user’s finger continuously detected by touch sensor 120 is no longer detected by touch sensor 120 immediately after the position of the user’s finger moved to the outer edge of input area A. When the position of the user’s finger continuously detected by touch sensor 120 has moved to the outer edge of input area A, and, further, is no longer detected by touch sensor 120, for example, controller 140 determines that the position touched by the user has moved from input area A to non-input area B. Meanwhile, when the position of the user’s finger continuously detected by touch sensor 120 is no longer detected by touch sensor 120 as touch input in a position other than the outer edge of input area A, or when the position of the user’s finger has been continuously detected by touch sensor 120, for example, controller 140 determines that the position touched by the user has not moved from input area A to non-input area B.

Note that the position of the outer edge of input area A may be freely defined in advance without being limited to a specific position. Information indicating the position of the outer edge of input area A is stored, for example, in memory 160 in advance.

Also, when the position touched by the user has moved from input area A to non-input area B with the user touching operation panel 110, for example, controller 140 causes vibrator 130 to vibrate at least non-input area B on operation panel 110. When touch sensor 120 detects a touch by the user in input area A before a first predetermined period elapses after the position touched by the user has moved from input area A to non-input area B or when the first predetermined period has elapsed, controller 140 then causes vibrator 130 to stop vibrating. Stated differently, controller 140 causes vibrator 130 to continue to vibrate for a certain duration of time even after the finger touching input area A crosses the boundary between input area A and non-input area B. Controller 140 also causes vibrator 130 to stop vibrating, for example, when the finger has returned to input area A.

The first predetermined period is set, for example, to 1 second, but may be freely defined in advance without being limited to a specific period. Information indicating the first predetermined period may be stored, for example, in memory 160 in advance.

Input device 100 may also include a timekeeper for keeping time, such as a Real-Time Clock (RTC).

Controller 140 may also control the vibration of vibrator 130 on the basis of the movement speed, which is the speed at which the position touched by the user moves on operation panel 110. When the position touched by the user has moved from input area A to non-input area B with the user touching operation panel 110, for example, controller 140 causes vibrator 130 to vibrate non-input area B at a vibration intensity (e.g., amplitude) that is based on the movement speed of the position touched by the user. Controller 140 calculates (estimates) the movement speed of the user's finger, for example, on the basis of the amount of movement of the position touched by the user (touch position). Controller 140 increases the vibration intensity of a vibration (warning vibration), for example, with an increasing speed of the movement speed. The higher the movement speed, the smaller the touch pressure of the finger and the touch area between the finger and operation panel 110. As a result, it becomes more difficult for the user to perceive the vibration. By increasing the vibration intensity of the vibration with an increasing speed of the movement speed, it is possible to reduce the difficulty the user has in perceiving the vibration.

Note that the relationship between the movement speed and the vibration intensity may be freely defined without being limited to a specific relationship. Information indicating the relationship between the movement speed and the vibration intensity is stored, for example, in memory 160 in advance.

Furthermore, controller 140 determines the timing (first timing) at which vibrator 130 starts vibrating when the position touched by the user has moved from input area A to non-input area B, for example, on the basis of the movement speed of the position touched by the user. For example, controller 140 calculates (estimates) the movement direction of the finger and the speed of the finger on the basis of the touch-input position, the movement direction of such position, and the amount of movement of such position. Then, controller 140 calculates (estimates) the time at which the finger reaches the touch input boundary on the basis of the result of such estimation and causes vibrator 130 to vibrate at the estimated time (timing).

Note that the relationship between the movement speed and the timing may be freely defined without being limited to a specific relationship. Information indicating the relationship between the movement speed and the timing is stored, for example, in memory 160 in advance. More specifically, controller 140 may calculate (estimate) the movement direction of the finger and the speed of the finger, for example, on the basis of the touch-input position, the movement direction of such position, and the amount of movement of such position. Then, controller 140 may read out the timing (more specifically, information indicating the timing) stored in memory 160, on the basis of the result of such estimation, and cause vibrator 130 to vibrate at the readout time (timing).

When touch sensor 120 detects a touch (i.e., touch input) by the user in input area A, for example, controller 140 causes vibrator 130 to vibrate input area A at a second vibration intensity that is weaker (e.g., smaller in amplitude) than a first vibration intensity, which is the vibration intensity used for the case where the position touched by the user has moved from input area A to non-input area B with the user touching operation panel 110. This enables the user to recognize that his/her finger is within input area A, when such user touches operation panel 110, without looking at his/her hands. Stated differently, controller 140 causes vibrator 130 to generate a strong vibration when controller 140 determines that the finger has moved from input area A to non-input area B, and causes vibrator 130 to generate a weak vibration (effective vibration) when touch input is simply detected in input area A.

Note that the first vibration intensity and the second vibration intensity may be freely defined without being limited to specific vibration intensities. Information indicating the first vibration intensity and the second vibration intensity is stored, for example, in memory 160 in advance.

Communicator 150 is a communication interface for communicating with display device 200. Communicator 150 may be realized, for example, in the form of a connector to which a communication line is connected to enable wired communication with display device 200, or may be realized, for example, in the form of an antenna and a wireless communication circuit to enable wireless communication with display device 200. The communication standard used by communicator 150 may be freely defined without being limited to a specific communication standard.

Memory 160 is a storage device for storing various information. Memory 160 may be realized, for example, in the form of a Hard Disk Drive (HDD) or a semiconductor memory.

Vibration device fixing component 170 is a component which is connected to operation panel 110 and in which vibrator 130 is located. Vibration device fixing component 170 is, for example, a tube-shaped case having a bottom, and houses vibrator 130. Operation panel 110 is located, for example, to cover an opening of vibration device fixing component 170. With this, touch sensor 120 is housed in vibration device fixing component 170 in the present embodiment. Vibrator 130 vibrates vibration device fixing component 170, thereby vibrating operation panel 110 that is connected to vibration device fixing component 170. Vibration device fixing component 170 is formed using a material such as polycarbonate, acrylic, and/or ABS resin.

Note that vibrator 130 may also be directly located in operation panel 110.

Main body cover 180 is a housing connected to operation panel 110 and houses touch sensor 120, vibrator 130, and vibration device fixing component 170. Main body cover 180 is, for example, a tube-shaped case having a bottom, and houses vibrator 130 and vibration device fixing component 170. Operation panel 110 is located, for example, to cover an opening of main body cover 180. With this, touch sensor 120 is housed in main body cover 180 in the present embodiment. Main body cover 180 is formed using a material such as polycarbonate, acrylic, and/or ABS resin.

Note that the materials used for operation panel 110, vibration device fixing component 170, and main body cover 180 may be the same or mutually different.

Also, input area A may include a plurality of divided areas.

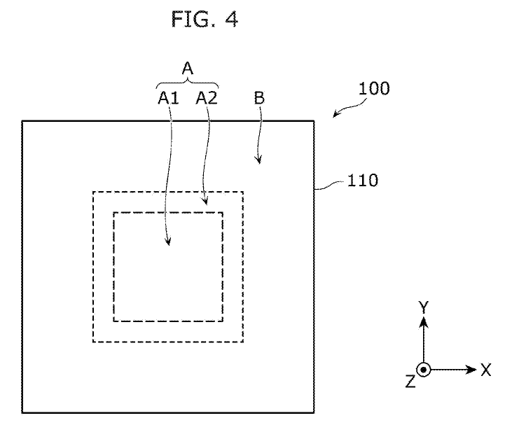

FIG. 4 is a diagram for describing first input area A1 and second input area A2 according to the embodiment.

Input area A includes first input area A1 and second input area A2 located closer to non-input area B than first input area A1 is.

First input area A1 and second input area A2 are areas for receiving touch input. Touch sensor 120 is provided on the back surface of each of first input area A1 and second input area A2, which is the surface opposing the main surface of operation panel 110. First input area A1 is located in the central portion on the main surface of operation panel 110 in a plan view.

Second input area A2 is an area in input area A on operation panel 110 other than first input area A1 and is an area located closer to non-input area B than first input area A1 is. Second input area A2 is located, for example, around first input area A1 in a manner that second input area A2 borders the outer perimeter of first input area A1 and surrounds first input area A1. Stated differently, second input area A2 is an area located in the outer edge portion of input area A.

Note that the shapes of first input area A1 and second input area A2 in a plan view may be freely defined without being limited to specific shapes. The main surface of operation panel 110 is configured, for example, for the user not to perceive the boundary between first input area A1 and second input area A2 visually or through touching.

When the position touched by the user has moved from first input area A1 to second input area A2 with the user touching operation panel 110, for example, controller 140 causes vibrator 130 to vibrate second input area A2 by controlling vibrator 130.

The distance between the outer edge of first input area A1 and the outer edge of second input area A2 is, for example, 20 mm, but may be freely defined without being limited to a specific distance. Information indicating the position of first input area A1 and the position of second input area A2 is stored, for example, in memory 160 in advance.

When the position touched by the user has moved from first input area A1 to second input area A2 with the user touching operation panel 110, or more specifically, when controller 140 determines that the position touched by the user has moved from first input area A1 to second input area A2, for example, controller 140 causes vibrator 130 to vibrate second input area A2. When controller 140 determines that the position touched by the user has continuously moved from first input area A1 to second input area A2, for example, controller 140 causes vibrator 130 to vibrate second input area A2.

When the position touched by the user has moved from first input area A1 to second input area A2 with the user touching operation panel 110, for example, controller 140 causes vibrator 130 to vibrate second input area A2 with a vibration of second input area A2 intensified as the position touched by the user approaches non-input area B. Stated differently, controller 140 causes vibrator 130 to generate a vibration (advance warning vibration) that is gradually intensified, for example, as the position touched by the user approaches non-input area B from the boundary (specified boundary) between first input area A1 and second input area A2. The specified boundary is located more inward on operation panel 110 in a plan view than the boundary (touch input boundary) between input area A (more specifically, second input area A2) and non-input area B. The position of the specified boundary is located, for example, 20 mm inside the touch input boundary on operation panel 110 in a plan view, but may be freely defined without being limited to a specific position.

The relationship between the position touched by the user and the vibration intensity may be freely defined without being limited to a specific relationship. Information indicating the relationship between the position touched by the user and the vibration intensity is stored, for example, in memory 160 in advance. The vibration may be intensified linearly or non-linearly (e.g., in a step-wise manner) as the position touched by the user approaches non-input area B.

When the position touched by the user has moved from first input area A1 to second input area A2 with the user touching operation panel 110, for example, controller 140 causes vibrator 130 to vibrate second input area A2 for a second predetermined period, which is shorter than the first predetermined period. Stated differently, controller 140 causes vibrator 130 to generate, for example, the advance warning vibration at the specified boundary for a short period of time.

Note that the second predetermined period may be set, for example, to 1 millisecond, but may be freely defined without being limited to a specific period. Information indicating the second predetermined period is stored, for example, in memory 160 in advance.

When the position touched by the user has moved from first input area A1 to second input area A2 with the user touching operation panel 110, for example, controller 140 causes vibrator 130 to vibrate second input area A2, on the basis of the movement speed of the position touched by the user, (i) with a vibration of second input area A2 intensified as the position touched by the user approaches non-input area B, or (ii) for the second predetermined period that is shorter than the first predetermined period. Stated differently, controller 140 may switch between executing the process of mode (i) and the process of mode (ii) on the basis of the movement speed of the position touched by the user on operation panel 110. Stated differently, controller 140 calculates (estimates) the movement speed of the finger on the basis of the amount of movement of the touch-input position to determine whether to cause vibrator 130 to operate in mode (i) or mode (ii), on the basis of the calculated movement speed, and causes vibrator 130 to generate the advance warning vibration in the mode that is based on the result of such determination. For example, controller 140 causes vibrator 130 to execute the process of mode (i) when the movement speed is below a predetermined threshold and the process of mode (ii) when the movement speed is greater than or equal to the predetermined threshold. The predetermined threshold may be set, for example, to 20 mm/s, but may be freely defined without being limited to a specific threshold. Information indicating the predetermined threshold is stored, for example, in memory 160 in advance.

Furthermore, controller 140 determines the timing (second timing) at which vibrator 130 starts vibrating when the position touched by the user has moved from first input area A1 to second input area A2, on the basis of the movement speed of the position touched by the user. For example, controller 140 calculates (estimates) the movement direction of the finger and the speed of the finger on the basis of the touch-input position, the movement direction of such position, and the amount of movement of such position. Then, controller 140 calculates (estimates) the time at which the finger reaches the specified boundary on the basis of the result of such estimation, and causes vibrator 130 to vibrate at the estimated time (timing).

Note that the relationship between the movement speed and the timing may be freely defined without being limited to a specific relationship. Information indicating the relationship between the movement speed and the timing is stored, for example, in memory 160 in advance. Also, controller 140 may, for example, calculate (estimate) the movement direction of the finger and the speed of the finger on the basis of the touch-input position, the movement direction of such position, and the amount of movement of such position. Then, controller 140 may calculate (estimate) the time at which the finger reaches the specified boundary (i.e., the timing at which the finger moves to second input area A2), on the basis of the result of such estimation, and cause vibrator 130 to vibrate at the estimated time (timing).

When the position touched by the user has moved from first input area A1 to second input area A2 with the user touching operation panel 110, for example, controller 140 causes vibrator 130 to vibrate second input area A2 at the vibration intensity that is based on the movement speed of the position touched by the user.

Note that the relationship between the movement speed and the vibration intensity may be freely defined without being limited to a specific relationship. Information indicating the relationship between the movement speed and the vibration intensity is stored, for example, in memory 160 in advance.

The relationship between the movement speed and the vibration intensity for the case where the position touched by the user has moved from first input area A1 to second input area A2 may be the same as or different from the relationship for the case where the position touched by the user has moved from input area A to non-input area B.

As described above, controller 140 causes vibrator 130 to vibrate input area A at the second vibration intensity when touch sensor 120 detects a touch by the user in input area A. Here, controller 140 causes vibrator 130 to vibrate first input area A1 at the second vibration intensity, for example, when touch sensor 120 detects a touch by the user in first input area A1 out of first input area A1 and second input area A2. Controller 140 may not cause vibrator 130 to vibrate when touch sensor 120 detects a touch by the user in second input area A2 out of first input area A1 and second input area A2.

Note that controller 140 may cause vibrator 130 to stop vibrating when touch sensor 120 detects a movement of the position touched by the user after detecting a touch by the user in input area A. More specifically, controller 140 may cause vibrator 130 to vibrate the main surface of operation panel 110 at a weak vibration intensity, i.e., cause vibrator 130 to generate a continuous vibration at the second vibration intensity, when the finger touching operation panel 110 is within the input area, and may cause vibrator 130 to stop vibrating (continuous vibration) after the finger moves after the reception of touch input is started. Furthermore, controller 140 may cause vibrator 130 to stop the vibration for notifying that the finger has touched first input area A1 when touch sensor 120 detects a movement of the position touched by the user after detecting a touch by the user in first input area A1 out of first input area A1 and second input area A2.

The positions (areas) in operation panel 110, conditions, start timings, periods, and vibration intensities used by controller 140 to cause vibrator 130 to vibrate, as described above, may be realized using a free combination of these.

### Processing Procedure

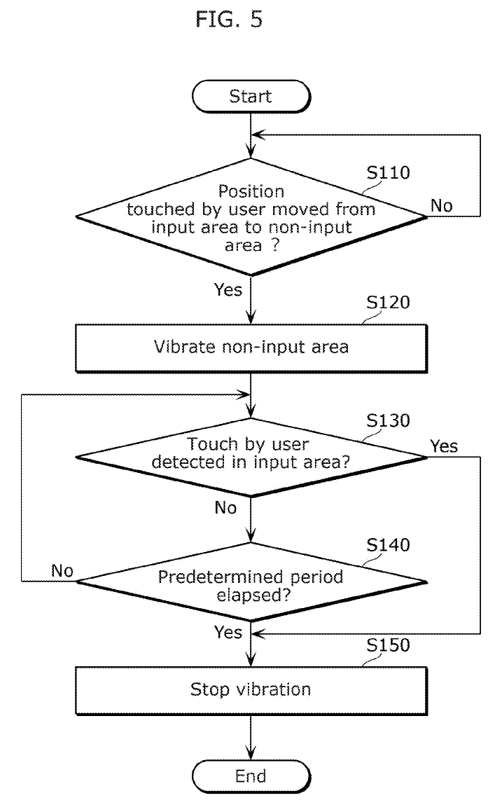

FIG. 5 is a flowchart showing Example 1 of the procedure of the processing performed by input device 100 according to the embodiment. Note that FIG. 5 shows the procedure of the processing related to the control performed on vibrator 130 after input device 100 receives touch input in input area A. Although not shown, controller 140 controls, for example, display device 200 in response to the touch input received by touch sensor 120.

First, input device 100 determines whether the position touched by the user has moved from input area A to non-input area B with the user touching operation panel 110 (S110).

When input device 100 determines that the position touched by the user has not moved from input area A to non-input area B with the user touching operation panel 110 (No in S110), input device 100, for example, continues the process of step S110.

Meanwhile, when input device 100 determines that the position touched by the user has moved from input area A to non-input area B with the user touching operation panel 110 (Yes in S110), input device 100 causes vibrator 130 to vibrate at least non-input area B on operation panel 110 by controlling vibrator 130 (S120).

Next, input device 100 determines whether touch sensor 120 has detected a touch (touch input) by the user in input area A (S130). When input device 100 determines, in step S110, whether the position touched by the user has moved from input area A to non-input area B on the basis of whether the position of the user’s finger has moved to the outer edge of input area A, for example, input device 100 determines whether touch sensor 120 has detected touch input at a position other than the outer edge of input area A. Alternatively, when input device 100 determines, in step S110, whether the position touched by the user has moved from input area A to non-input area B on the basis of whether touch input is no longer detected, for example, input device 100 determines whether touch sensor 120 has detected touch input in input area A, including the outer edge.

When input device 100 determines that touch sensor 120 has not detected a touch by the user in input area A (No in S130), input device 100 determines whether the predetermined period (first predetermined period) has elapsed after causing vibrator 130 to start vibrating (S140).

When input device 100 determines that the predetermined period has not elapsed after causing vibrator 130 to start vibrating (No in S140), input device 100 returns to the process of step S130.

Meanwhile, when input device 100 determines that touch sensor 120 has detected touch input by the user in input area A (Yes in S130), or when input device 100 determines that the predetermined period has elapsed after causing vibrator 130 to start vibrating (Yes in S140), input device 100 causes vibrator 130 to stop vibrating (S150).

Note that, in step S120, input device 100 is simply required to cause vibrator 130 to vibrate at least non-input area B on operation panel 110, and thus may cause vibrator 130 to vibrate the whole of operation panel 110.

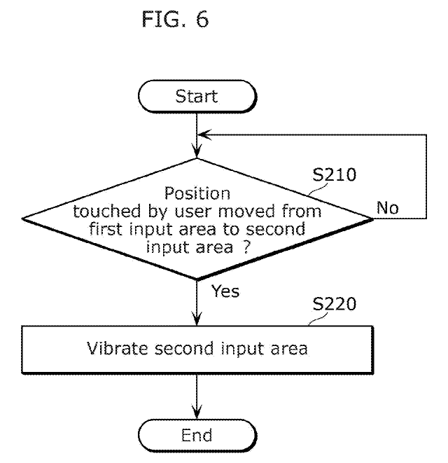

FIG. 6 is a flowchart showing Example 2 of the procedure of the processing performed by input device 100 according to the embodiment. Note that FIG. 6 shows the procedure of the processing related to the control performed on vibrator 130 after input device 100 receives touch input in input area A. Although not shown, controller 140 controls, for example, display device 200 in response to the touch input received by touch sensor 120.

First, input device 100 determines whether the position touched by the user has moved from first input area A1 to second input area A2 with the user touching operation panel 110 (S210). Input device 100 determines, for example, whether the position of the user’s finger detected by touch sensor 120 in first input area A1 has moved to second input area A2. Stated differently, input device 100 determines, for example, whether touch sensor 120 has detected, in second input area A2, the position of the user’s finger continuously detected by touch sensor 120 in first input area A1.

When input device 100 determines that the position touched by the user has not moved from first input area A1 to second input area A2 with the user touching operation panel 110 (No in S210), input device 100 continues, for example, the process of step S210.

Meanwhile, when input device 100 determines that the position touched by the user has moved from first input area A1 to second input area A2 with the user touching operation panel 110 (Yes in S210), input device 100 causes vibrator 130 to vibrate at least second input area A2 by controlling vibrator 130 (S220).

Note that, in step S220, input device 100 is simply required to cause vibrator 130 to vibrate at least second input area A2 on operation panel 110, and thus may cause vibrator 130 to vibrate the whole of operation panel 110.

Input device 100 may perform processes equivalent to steps S130 to S150 after performing step S220. For example, after step S220, input device 100 may determine whether touch sensor 120 has detected touch input by the user in first input area A1. When input device 100 determines that touch sensor 120 has not detected touch input by the user in first input area A1, input device 100 may then determine whether the predetermined period (first predetermined period) has elapsed after causing vibrator 130 to start vibrating. When input device 100 determines that the predetermined period has not elapsed after causing vibrator 130 to start vibrating, for example, input device 100 may determine again whether touch sensor 120 has detected touch input by the user in first input area A1. When input device 100 determines that touch sensor 120 has detected touch input by the user in first input area A1, or when input device 100 determines that the predetermined period has elapsed after causing vibrator 130 to start vibrating, input device 100 may cause vibrator 130 to stop vibrating.

### Effects, etc.

As described above, input device 100 includes: operation panel 110 that includes input area A for receiving touch input from a user and non-input area B not for receiving the touch input; touch sensor 120 that detects a position touched by the user, the position being located in input area A on operation panel 110; vibrator 130; and controller 140 that causes vibrator 130 to vibrate at least non-input area B on operation panel 110 by controlling vibrator 130 when the position touched by the user has moved from input area A to non-input area B with the user touching operation panel 110.

With this, it is possible to notify the user, through vibration, of that the finger has moved to outside the input area for receiving touch input while the user is performing a sliding operation. More specifically, it is possible to enable the user to recognize, through vibration, that the position touched by the user has moved to outside input area A, without needing to provide, for example, a concave/convex portion on the main surface of operation panel 110. Thus, with input device 100, it is possible to prevent a decrease in the design quality and facilitate the recognition of the position touched by the user. More specifically, it is possible to maintain the design quality of the top surface of input device 100 (seamless, clean appearance) while enabling the user to recognize the boundary between the area for receiving touch input and the area not for receiving touch input, through vibration.

Also, input device 100 includes operation panel 110, touch sensor 120, vibrator, 130, and controller 140. Input area A includes first input area A1 and second input area A2 that is located closer to non-input area B than first input area A1 is. Controller 140 causes vibrator 130 to vibrate second input area A2 by controlling vibrator 130 when the position touched by the user has moved from first input area A1 to second input area A2 with the user touching operation panel 110.

With this, it is possible to notify the user of that the user’s finger has moved to second input area A2, or in other words, that the user’s finger is approaching non-input area B. More specifically, for example, it is possible to enable the user to recognize, through vibration, that the position touched by the user is about to move to outside input area A, without the need for operation panel 110 having different surface shapes for input area A and for non-input area B. Thus, with input device 100, it is possible to prevent a decrease in the design quality and facilitate the recognition of the position touched by the user.

These general or specific aspects may be implemented using a system, a method, an integrated circuit, a computer program, or a non-transitory recording medium such as a computer-readable CD-ROM, or may also be implemented using any combination of systems, methods, integrated circuits, computer programs, or recording media. The program may be stored in the recording medium in advance, or may be supplied to the recording medium over a wide area network such as the Internet.

In the control method for controlling input device 100, when the position touched by the user has moved from input area A to non-input area B with the user touching operation panel 110 (Yes in S110), for example, control is performed on vibrator 130 to cause vibrator 130 to vibrate at least non-input area B on operation panel 110 (S120).

Furthermore, in the control method for controlling input device 100, when the position touched by the user has moved from first input area A1 to second input area A2 with the user touching operation panel 110 (Yes in S210), for example, control is performed on vibrator 130 to cause vibrator 130 to vibrate input area A2 (S220).

According to the above aspects, it is possible to achieve the same effects as those achieved by input device 100.

### Variations

The following describes variations of the input device. The following focuses on differences from input device 100, and simplifies or omits the descriptions of the configurations and processes common to input device 100.

### Variation 1

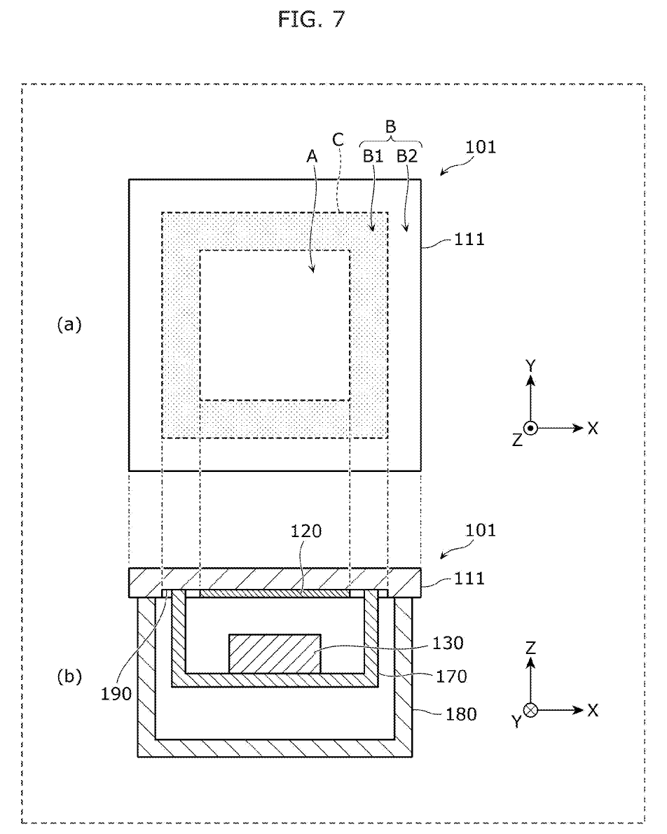

FIG. 7 is a diagram showing the configuration of input device 101 according to Variation 1. As with input device 100, input device 101, includes controller 140, communicator 150, and memory 160.

Different from operation panel 110, operation panel 111 included in input device 101 includes groove portion 190.

Operation panel 111 is a panel that includes input area A for receiving touch input from the user and non-input area B not for receiving such touch input.

Groove portion 190 is a recessed portion provided on the back surface of operation panel 111, which is the surface opposing the main surface. Groove portion 190 is provided, for example, in a manner that groove portion 190 overlaps input area A and part of non-input area B (more specifically, first non-input area) in a plan view.

In the present example, non-input area B includes first non-input area B1 and second non-input area B2, which is farther from input area A than first non-input area B1 is. More specifically, first non-input area B1 is located between input area A and second non-input area B2. First non-input area B1 is an area, in non-input area B, that overlaps groove portion 190 in a plan view. Second non-input area B2 is an area, in non-input area B, that does not overlap groove portion 190 in a plan view.

First non-input area B1 is located, for example, around input area A in a manner that first non-input area B1 borders the outer perimeter of input area A and surrounds input area A. Second non-input area B2 is located, for example, around first non-input area B1 in a manner that second non-input area B2 borders the outer perimeter of first non-input area B1 and surrounds first non-input area B1.

Note that the shapes of first non-input area B1 and second non-input area B2 in a plan view may be freely defined without being limited to specific shapes. The main surface of operation panel 111 is configured, for example, for the user not to perceive the boundary between first non-input area B1 and second non-input area B2 visually or through touching.

As a result of forming groove portion 190 in operation panel 111, thinned area C is formed that is smaller in thickness (in the present example, the width in the Z-axis direction on operation panel 111), that is, thinner, than the other portions in operation panel 111.

Thinned area C is an area, in operation panel 111, that is encapsulated in groove portion 190 in a plan view. As described above, operation panel 111 is relatively thin at least in input area A (more specifically, compared to second non-input area B2). Operation panel 111 is also relatively thin at least in first non-input area B1 (more specifically, compared to second non-input area B2).

Note that the thickness of input area A may be the same as or different from the thickness of first non-input area B1.

Touch sensor 120 is located, for example, in groove portion 190. Furthermore, vibration device fixing component 170 is connected to operation panel 111 at groove portion 190.

Note that the depth of the groove of groove portion 190 (the width in the Z-axis direction) is, for example, 2 mm, but may be freely defined without being limited to a specific depth.

The shape of groove portion 190 in a plan view and the shape of thinned area C in a plan view may be freely defined without being limited to specific shapes. The shape of thinned area C in a plan view is, for example, a shape similar to the shape of input area A in a plan view (more specifically, the ratio of the width in the X-axis direction to the width in the Y-axis direction is the same).

The distance between the outer edge of groove portion 190 and the outer edge of input area A in a plan view is, for example, 30 mm, but may be freely defined without being limited to a specific distance.

As described above, input device 101 includes operation panel 111, touch sensor 120, vibrator 130, and controller 140. Non-input area B on operation panel 111 includes first non-input area B1 located close to input area A and second non-input area B2 located farther from input area A than first non-input area B1 is. Input area A and first non-input area B1 are thinner than second non-input area B2.

Groove portion 190 is provided on the back surface of operation panel 111, for example, in a manner that groove portion 190 has a shape similar to input area A1 in a plan view and becomes relatively thin to the position that is a specific distance away from the touch input boundary (more specifically, to the position where a vibration is intended to be felt by the user). Furthermore, operation panel 111 is thin, for example, as far as at least the outer edge of the area where the vibration is intended to be felt by the finger. Also, since the vibration of vibrator 130 is transmitted to operation panel 111 from the connection point between vibration device fixing component 170 and operation panel 111, such connection point is located in thinned area C (more specifically, on the back surface of thinned area C).

As described above, a thinned portion (groove portion 190) is provided in operation panel 111, thereby making it easier for vibrator 130 to vibrate operation panel 111. In particular, when the overall thickness of operation panel 111 is large, a thinned portion provided in operation panel 111, even partially, enables vibrator 130 to easily vibrate operation panel 111. The foregoing configuration in which groove portion 190 is provided over a wide area is effective, in particular, when the thickness of operation panel 111 (e.g., the thickness of the portions other than groove portion 190) is relatively large, such as approximately 4 mm.

### Variation 2

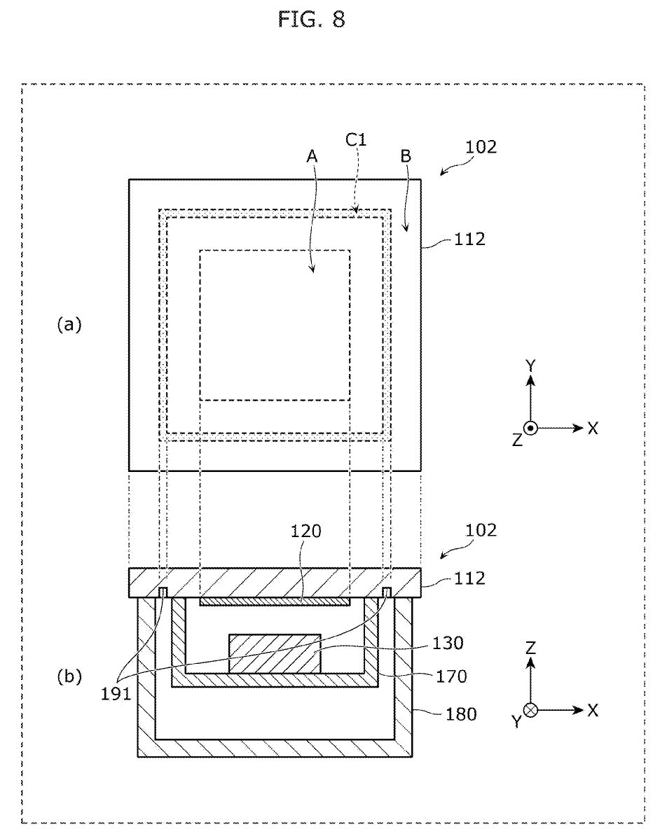

FIG. 8 is a diagram showing the configuration of input device 102 according to Variation 2. As with input device 100, input device 102 includes controller 140, communicator 150, and memory 160.

Different from operation panel 110, operation panel 112 included in input device 102 includes groove portion 191.

As with operation panel 110, operation panel 112 is a panel that includes input area A for receiving touch input from the user and non-input area B not for receiving such touch input.

Groove portion 191 is a recessed portion provided on the side opposing the side on which the main surface of operation panel 112 is located. Groove portion 191 is provided, for example, in non-input area B. Groove portion 191 is configured, for example, in the form of a continuous groove that surrounds input area A in a plan view.

As a result of forming groove portion 191 in operation panel 112, thinned area C1 is formed that is smaller in thickness (in the present example, the width in the Z-axis direction on operation panel 112), that is, thinner, than the other portions in operation panel 112.

Thinned area C1 is an area in operation panel 112 that overlaps groove portion 191 in a plan view. Thinned area C1 is, for example, hollow and rectangular in shape in a plan view. Groove portion 191 is located on the back surface of operation panel 112 to form a relatively thinned portion on the outer side of input area A in a plan view.

For example, groove portion 191 is provided in non-input area B on operation panel 112 on the outer side relative to the connection point in a plan view, which is a point located between operation panel 112 and vibration device fixing component 170. More specifically, groove portion 191 is provided between the outer edge of operation panel 112 in a plan view and the connection point between operation panel 112 and vibration device fixing component 170.

Note that the depth of the groove of groove portion 191 (the width in the Z-axis direction) is, for example, 1 mm, but may be freely defined without being limited to a specific depth. Also, the width of the groove of groove portion 191 (the width in the X-axis direction or the Y-axis direction) is, for example, 1 mm, but may be freely defined without being limited to a specific width.

Also, the shape of groove portion 191 in a plan view (i.e., the shape of thinned area C1 in a plan view) may be freely defined without being limited to a specific shape. The shape of thinned area C1 in a plan view (the shape of the outer edge of thinned area C1 in a plan view) is, for example, a shape similar to the shape of input area A in a plan view (more specifically, the ratio of the width in the X-axis direction to the width in the Y-axis direction is the same).

Also, the distance between groove portion 191 and the touch input boundary in a plan view is, for example, 30 mm, but may be freely defined without being limited to a specific distance.

As described above, input device 102 includes operation panel 112, touch sensor 120, vibrator 130, and controller 140. Operation panel 112 includes groove portion 191 in non-input area B provided in operation panel 112 on the outer side relative to the connection point in a plan view, which is a point located between operation panel 112 and vibration device fixing component 170 to which vibrator 130 is connected.

Groove portion 191 that is relatively thin is provided on the back surface of operation panel 112, for example, in a manner that groove portion 191 has a shape similar to input area A in a plan view and is located at a position that is specific distance away from the touch input boundary (more specifically, at the position where a vibration is intended to be felt by the user). Furthermore, operation panel 112 is thin at the outer edge of the area in which, for example, the vibration is intended to be felt by the finger. Also, since the vibration of vibrator 130 is transmitted to operation panel 112 from the connection point between vibration device fixing component 170 and operation panel 112, such connection point is located at a position, in operation panel 112, that is more inward than thinned area C1 in a plan view.

As described above, since groove portion 191 is thinner than the other portions in operation panel 112, it is easier for vibrator 130 to vibrate operation panel 112 without reducing the rigidity of operation panel 112. The foregoing configuration in which groove portion 191 is partially provided is effective, in particular, when the thickness of operation panel 112 (e.g., the thickness of the portions other than groove portion 191) is relatively small, such as approximately 2 mm.

### Other Embodiments

The input device according to one or more aspects have been described above on the basis of the embodiment, but the present disclosure is not limited to such embodiment. The scope of the present disclosure may also include an embodiment achieved by making various modifications to the embodiment that can be conceived by those skilled in the art and an embodiment achieved by freely combining some of the elements in different embodiments without departing from the essence of the present disclosure.

For example, the configurations and the procedures of the processing performed by input device 100, input device 101, and input device 102 may be freely combined. In an input device that includes groove portion 190 provided in operation panel 111, such as input device 101, for example, processing may be performed for input area A separately for the first input area and the second input area. Also, in an input device that includes groove portion 191 provided in operation panel 112, such as input device 102, for example, processing may be performed for input area A separately for the first input area and the second input area. Groove portion 191 may be provided on the back surface of operation panel 112 on the outer side of the specified boundary in a plan view. Also, for example, the processing for generating the warning vibration, the processing for generating the advance warning vibration, and the processing for generating the effective vibration may be freely combined.

Furthermore, the position to be vibrated by vibrator 130 is simply required to be, for example, at least non-input area B on operation panel 110 when indicated so, and thus the whole of operation panel 110 may be vibrated. The same applies to other descriptions.

Furthermore, in the foregoing embodiment, display device 200 is operated, for example, on the basis of touch input performed to input device 100. The target to be operated by input device 100 is not specifically limited to display device 200. The target to be operated by input device 100 may also be, for example, air conditioning equipment or audio equipment included in the vehicle, may be a smartphone or other devices of the user, or may be equipment located outside the vehicle.

Also, in the foregoing embodiment, each of the elements may be configured in the form of an exclusive hardware product, or may be realized by executing a software program suitable for the element. Each of the elements may be realized by means of a program executing unit, such as a CPU and a processor, reading and executing the software program recorded on a recording medium such as a hard disk or a semiconductor memory.

The orders of performing the steps in the flowcharts are examples to specifically describe the present disclosure, and thus may be orders other than the foregoing orders. Also, some of the steps may be performed simultaneously (in parallel) with another step and some of the steps may not be performed.

Also, the division of the functional blocks in the block diagrams is an example, and thus a plurality of functional blocks may be realized in the form of a single functional block, a single functional block may be divided into a plurality of blocks, or some of the functions may be moved to another functional block. Also, the functions of a plurality of functional blocks having similar functions may be processed by hardware or software in parallel or in a time-shared manner.

Also, the elements described in the foregoing embodiment may be realized in the form of software or in the form of a large-scale integration (LSI), which is typically an integrated circuit. These may take the form of individual chips, or may be encapsulated into a single chip to include some or all of the elements. Although the elements in the foregoing embodiment are described here as being realized in the form of an LSI, LSI is also referred to as IC, system LSI, super LSI, or ultra LSI, depending on their degree of integration. Also, the technique of circuit integration is not limited to LSI, and the elements described in the foregoing embodiment may be realized using a dedicated circuit (general-purpose circuit that executes an exclusive program) or a general-purpose processor. Also, a field programmable gate array (FPGA) that allows for programming after the manufacture of an LSI or a reconfigurable processor that allows for reconfiguration of the connection and the settings of circuit cells inside an LSI may be employed. Furthermore, when a new circuit integration technology that replaces LSI emerges as a result of the future progress in a semiconductor technology or other derivative technologies, such new technology may also be employed to integrate the elements.

The system LSI is a super-multifunctional LSI that is manufactured by integrating a plurality of processing units onto a single chip. The system LSI is, more specifically, a computer system that includes a microprocessor, a ROM, a RAM, etc. The ROM stores a computer program. The microprocessor’s operating in accordance with the computer program enables the system LSI to accomplish its function.

An aspect of the present disclosure may also be a computer program for causing a computer to execute the characteristic steps included in the foregoing control method.

Furthermore, the program may be, for example, a program to be executed by a computer. An aspect of the present disclosure may also be a non-transitory computer-readable recording medium having recorded thereon such a program. For example, such a program may be recorded in a recording medium to be distributed or circulated. For example, the distributed program is installed in a device that includes another processor to cause the processor to execute the program, thereby causing such device to perform the processing described above.

Further Information about Technical Background to this Application

The disclosure of the following patent application including specification, drawings, and claims is incorporated herein by reference in its entirety: Japanese Patent Application No. 2025-034687 filed on March 5, 2025.

### INDUSTRIAL APPLICABILITY

The present disclosure is applicable for use as, for example, devices that receive touch input from a user.

1. An input device comprising:
an operation panel that includes an input area for receiving touch input from an operating body and a non-input area not for receiving the touch input;
a touch sensor that detects a position touched by the operating body, the position being located in the input area on the operation panel;
a vibrator; and
a control circuit that causes the vibrator to vibrate at least the non-input area on the operation panel by controlling the vibrator when the position touched by the operating body has moved from the input area to the non-input area with the operating body touching the operation panel.

2. The input device according to claim 1,
wherein the control circuit causes the vibrator to:
vibrate at least the non-input area on the operation panel when the position touched by the operating body has moved from the input area to the non-input area with the operating body touching the operation panel; and
stop vibrating when the touch sensor detects a touch by the operating body in the input area before a first predetermined period elapses after the position touched by the operating body has moved from the input area to the non-input area, or when the first predetermined period has elapsed.

3. The input device according to claim 1,
wherein the control circuit causes the vibrator to vibrate the non-input area at a vibration intensity that is based on a movement speed when the position touched by the operating body has moved from the input area to the non-input area with the operating body touching the operation panel, the movement speed being a speed at which the position touched by the operating body moves.

4. The input device according to claim 2,
wherein the input area includes a first input area and a second input area that is located closer to the non-input area than the first input area is, and
the control circuit causes the vibrator to vibrate the second input area when the position touched by the operating body has moved from the first input area to the second input area with the operating body touching the operation panel.

5. The input device according to claim 4,
wherein the control circuit causes the vibrator to vibrate the second input area with a vibration of the second input area intensified as the position touched by the operating body approaches the non-input area when the position touched by the operating body has moved from the first input area to the second input area with the operating body touching the operation panel.

6. The input device according to claim 4,
wherein the control circuit causes the vibrator to vibrate the second input area for a second predetermined period that is shorter than the first predetermined period when the position touched by the operating body has moved from the first input area to the second input area with the operating body touching the operation panel.

7. The input device according to claim 4,
wherein when the position touched by the operating body has moved from the first input area to the second input area with the operating body touching the operation panel, the control circuit causes the vibrator to vibrate the second input area based on a movement speed (i) with a vibration of the second input area intensified as the position touched by the operating body approaches the non-input area or (ii) for a second predetermined period that is shorter than the first predetermined period, the movement speed being a speed at which the position touched by the operating body moves.

8. The input device according to claim 4,
wherein the control circuit determines, based on a movement speed, a timing at which the vibrator starts vibrating when the position touched by the operating body has moved from the input area to the non-input area, the movement speed being a speed at which the position touched by the operating body moves.

9. The input device according to claim 4,
wherein the control circuit determines, based on a movement speed, a timing at which the vibrator starts vibrating when the position touched by the operating body has moved from the first input area to the second input area, the movement speed being a speed at which the position touched by the operating body moves.

10. The input device according to claim 4,
wherein the control circuit causes the vibrator to vibrate the second input area at a vibration intensity that is based on a movement speed when the position touched by the operating body has moved from the first input area to the second input area with the operating body touching the operation panel, the movement speed being a speed at which the position touched by the operating body moves.

11. The input device according to claim 4,
wherein the control circuit causes the vibrator to vibrate the input area at a second vibration intensity that is weaker than a first vibration intensity when the touch sensor detects a touch by the operating body in the input area, the first vibration intensity being a vibration intensity used for a case where the position touched by the operating body has moved from the input area to the non-input area with the operating body touching the operation panel.

12. The input device according to claim 11,
wherein the control circuit causes the vibrator to vibrate the first input area at the second vibration intensity when the touch sensor detects a touch by the operating body in the first input area out of the first input area and the second input area.

13. The input device according to claim 11,
wherein the control circuit causes the vibrator to stop vibrating when the touch sensor detects a movement of the position touched by the operating body after detecting a touch by the operating body in the first input area.

14. The input device according to claim 1,
wherein the non-input area includes a first non-input area and a second non-input area that is farther from the input area than the first non-input area is, and
the input area and the first non-input area are thinner than the second non-input area.

15. The input device according to claim 1,
wherein the operation panel includes a groove portion in the non-input area, the groove portion being provided in the operation panel on an outer side relative to a connection point in a plan view, the connection point being located between the operation panel and a vibration device fixing component to which the vibrator is connected.

16. An input device comprising:
an operation panel that includes an input area for receiving touch input from an operating body and a non-input area not for receiving the touch input;
a touch sensor that detects a position touched by the operating body, the position being located in the input area on the operation panel;
a vibrator; and
a control circuit that controls the vibrator,
wherein the input area includes a first input area and a second input area that is located closer to the non-input area than the first input area is, and
the control circuit causes the vibrator to vibrate the second input area by controlling the vibrator when the position touched by the operating body has moved from the first input area to the second input area with the operating body touching the operation panel.

17. The input device according to claim 16,
wherein the control circuit causes the vibrator to vibrate the second input area at a vibration intensity that is based on a movement speed when the position touched by the operating body has moved from the first input area to the second input area with the operating body touching the operation panel, the movement speed being a speed at which the position touched by the operating body moves.

18. The input device according to claim 16,
wherein the control circuit causes the vibrator to vibrate the second input area with a vibration of the second input area intensified as the position touched by the operating body approaches the non-input area when the position touched by the operating body has moved from the first input area to the second input area with the operating body touching the operation panel.

19. The input device according to claim 16,
wherein the control circuit determines, based on a movement speed, a timing at which the vibrator starts vibrating when the position touched by the operating body has moved from the first input area to the second input area, the movement speed being a speed at which the position touched by the operating body moves.

20. A control method for controlling an input device including: an operation panel that includes an input area for receiving touch input from an operating body and a non-input area not for receiving the touch input; a touch sensor that detects a position touched by the operating body, the position being located in the input area on the operation panel; and a vibrator, the control method comprising:
causing the vibrator to vibrate at least the non-input area on the operation panel by controlling the vibrator when the position touched by the operating body has moved from the input area to the non-input area with the operating body touching the operation panel.
